(19) United States
(12) Patent Application Publication
(10) Pub. No.: US 2002/0035876 A1
(43) Pub. Date: Mar. 28, 2002

(54) Torque process control method and apparatus for fluid powered tools

(76) Inventor: Robert D. Donaldson JR., Commerce, GA (US)

Correspondence Address: GARDNER GROFF MEHRMAN & JOSEPHIC, P.C., PAPER MILL VILLAGE, BUILDING 23, 600 VILLAGE TRACE, SUITE 300, MARIETTA, GA, 30067, US

(21) Appl. No.: 09/803,128

(22) Filed: Mar. 8, 2001

Related U.S. Application Data
(60) Provisional application No. 60/187,897, filed on Mar. 8, 2000.
(60) Provisional application No. 60/220,561, filed on Jul. 25, 2000.

(51) Int. Cl. G01L 5/24

(52) U.S. Cl. 73/862.21

(57) ABSTRACT

A torque process control method and apparatus, including associated components, for fluid-powered tools such as impact and pulse-driven wrenches and nut runners.

### CROSS-REFERENCE TO RELATED APPLICATION

This application claims the benefit of U.S. Provisional Patent Application Ser. No. 60/187,897, filed Mar. 8, 2000, and U.S. Provisional Patent Application Ser. No. 60/220,561, filed Jul. 25, 2000. The entire scope and content of both of these applications is hereby incorporated herein by reference.

### BACKGROUND OF THE INVENTION

1. Field of the Invention

The present invention relates generally to power-driven tools; and more particularly to fluid-powered impact and pulse driven wrenches and nutrunners and associated components and control methods. The invention further relates to an improved method of process control of these devices and an improved mechanism for providing such process control and specifically a torque responsive, automatically torque-controlling, fluid powered tool of portable character.

2. Description of Related Art

Fluid powered tools, i.e., air powered and hydraulic powered tools, are widely used in repair, maintenance, manufacturing, assembly and other technical areas to apply torque (i.e., a twisting moment) to a bolt, screw, stud, nut, or other fastener, or joint, such as shear joints and tensile joints. Any and all of the foregoing elements subjected to torque shall be referred to in this description for convenience as “workpiece.”

Such portable tools of the above type may be driven by either air or oil as a working fluid and are more specifically described in industry and in the prior art as the nutrunner tool, impact wrench, or pulse tool depending upon the mechanical features contained therein.

An air driven nutrunner tool has a continuous drive air motor, such as a rotary vane motor, for driving the fastener. An oil driven nutrunner operates in a similar manner, but may use a positive displacement drive (such as a gear or turbine motor) in lieu of the air motor. It is desirable to monitor the torque applied by a nutrunner to the workpiece, and automatically shut off the nutrunner at a predetermined final tightened torque.

Although it is possible to measure torque on a nutrunner directly, by means of a strain gauge or other reaction torque transducer, measurement of the torque of a nutrunner by means of a direct measurement has been difficult and can be complicated by movement of the tool during tightening. Additionally, variations of environmental temperature further complicates this tool design through additional means needed for temperature correction. Such direct measurement transducers also considerably increase the cost of the nutrunner, require relatively high electrical power requirements necessitating remote located components with umbilical attachments, and more generally impedes any design effort to provide a tool of portable character and simplicity of operation. Moreover, such direct measurement transducers must generally be designed into the nutrunner, and cannot be conveniently retrofitted.

An impact wrench operates by releasing a periodic build up of kinetic energy in the form of a series of torsional shock impulses transmitted to a workpiece. As a result, considerable impact forces can be produced with little reactive torque sensed by the operator. An air driven impact wrench typically includes a vane type air motor and a hammer/anvil mechanism. When the air motor gains sufficient speed a high inertia of the hammer, driven by the motor shaft, engages an anvil mechanism on the wrench output shaft. This hammer/anvil impact thus drives a socket or other device that engages the output shaft to the workpiece. The energy of the blow is converted into several forms. It is (a) dissipated in the form of heat as a result of collision and friction; (b) stored as torsional strain energy in the impact mechanism, the wrench drive shaft, and the coupling to the fastener; and (c) transferred to the workpiece, and converted to torque. The hammer then disengages from the anvil and the motor accelerates for, typically, a complete revolution before delivering the next blow.

A pulse tool is an oil pulse impact wrench similar in operation to the impact wrench described above, except the hammer/anvil mechanism is enclosed in a chamber filled with hydraulic fluid which has the effect of damping the backlash and providing smoother operation resulting in less vibration, noise, and operator fatigue. While recent prior art is rich with variations of the pulse tool, the foregoing describes the majority of this fluid powered tool segment. The remaining examples take advantage of the smoother operating characteristics of the pulse impact mechanism, as compared to the impact wrench above, to incorporate a direct measurement torque transducer mechanism. All of these remaining examples, however, share the same operational and design limitations of direct torque measurement nutrunners sited above.

It is desirable to monitor and/or control the performance of impact wrenches for many of the same reasons as for pulse and nutrunner wrenches. However, because an impact wrench applies torque to the fastener by means of a series of impacts, as often as 20 times per second, it is difficult to directly measure the torque applied by an impact wrench. Consequently, it is difficult to accurately control a final torque applied to the workpiece through direct measurement means.

Due to the foregoing limitations of convenient direct torque measurement, it has been difficult to control the torque of air or oil powered nutrunner, pulse, and impact wrenches that is applied to a workpiece.

A remaining body of fluid powered torque controlled tools exists in the prior art that uses various means of clutch designs, torsion springs, or other mechanical methods of providing a measure of torque control to the workpiece. These designs each work only within a narrow and limited range of application in which several different tools are required to provide a typically needed range of operation. Additionally, these tools are complicated mechanical devices that require high precision machining and labor intensive fabrication, assembly, and maintenance. Calibration requirements are also very demanding and often require some maintenance intervention such as spring replacement to affect correct calibration to a known torque standard. Consequently the foregoing fluid powered tools having mechanical means for control of torque applied to a workpiece are expensive, complicated, and difficult to maintain.

While even the most expensive and complicated of devices may find a niche in some market segment, the foregoing limitations are further exacerbated in consideration of the need for an inexpensive, accurate, and reliable means of torque control in the general workplace (the term “general workplace” is used for convenience in this description to include general industrial maintenance, repair, and service, as well as farm, fleet, automotive, and other uses where economy, portability, and simplicity of use have historically been favored over precise torque control and accuracy). Further, it is well disclosed in the prior art that fluid powered tools having torque control features are predominately designed for the industrial assembly line and other high end markets where high cost and complexity are not considered barriers to acceptance within those markets. For example, as during the manufacture of engines wherein the need for statistical process control, standards trace-ability, and other quality control needs must be met.

Further, the development of fluid powered tools having torque control capability that is within the range of economy and ease of use needed for the general workplace, although such application is much greater in size and need, have not been forthcoming. For example, in automotive and light truck service, repair, and maintenance (which may simply be referred to in this description as “automotive use”) pneumatic impact wrenches, without torque control capability, are commonly used to apply torque to various kinds of fasteners. An example is the use of portable pneumatic impact wrenches used to tighten and loosen lug nuts, which fasten a wheel to a wheel flange, as during installation or replacement of wheels. To limit torque applied by pneumatic torque wrenches, tools have been equipped with air volume adjustment controls, which, by limiting the air flow rate to an air motor of the tool, can provide some approximate measure of torque control. But, in fact, an arrangement for limiting the air flow rate to the tool does not provide sufficient precision of control to predetermine a torque affect upon a workpiece.

The tool user, in this situation a tire installer/repairer for example, would most surely prefer an impact wrench with torque controlling capability, but, must instead rely on the use of a manually operated torque wrench since this is the only economical method presently available to the general workplace. While the forgoing example typifies current general workplace practice, it also illustrates yet another limitation of the prior art, wherein the opportunity for human error during the application of torque to a critical workpiece is much greater in the general workplace. This, in the example above, is simply due to the possibility that if an impact wrench is first used to install lug nuts, in an undetectably over-torqued condition, the user would not necessarily realize this fact when applying the use of a “clicker type” manually operated torque wrench. Here the operator would have a false sense of applying the correct torque to the workpiece, but, in actuality, would have only certified that the fastener has at least the minimum desired torque and can unknowingly place a seriously overtorqued workpiece in operation or service. The foregoing situation has been discovered and documented in accident investigations and U.S. court cases as the direct cause of vehicular accidents resulting in serious injuries and fatalities.

### SUMMARY OF THE INVENTION

It is in view of the above problems that the present invention was developed. In preferred embodiments, one aspect of the invention comprises a fluid powered tool providing: user calibration and adjustment capability, automatic shut off within a wide range of programmable torque settings, feedback indicators and process controls that reduce operator errors, low production cost, and simplicity of operation specifically designed to meet the needs for automotive use and the general workplace. The tool preferably provides truly portable, repeatable, and accurate torque process control without regard to operator capability or operating environment.

By way of simple explanation of physical principles applicable to an example embodiment of the invention, a pneumatic impact wrench comprises a fluid power motor drive, operating an impact clutch mechanism that imparts a desired final torque to a workpiece. The fluid power to the motor is strictly controlled by means of a manual depression of a trigger which starts the tool operation, and a pressure regulator in association with an unchangeable and fixed volume flow chamber located between the input of a regulator to the input of a motor, causing a known, anticipated, and consistent power output of the motor. Torque is applied to the workpiece during operation and starting from a consistent starting point with automatic tool shut off occurring at a variable and pre-programmable stopping point as monitored by an impact duration (time or number of impact counts) counting mechanism. At the preprogrammed stopping point the motor driving fluid is quickly turned off through an automatic means. The torque applied to a workpiece, once determined as a number of counts or timed event during the impact cycle, can thereby be reproduced in a consistent and reliable manner.

In one aspect, the invention is a method of controlling torque applied to a workpiece by a tool. The method preferably includes the steps of counting a number of impacts applied by the tool to the workpiece, and controlling the number of impacts applied by the tool to the workpiece to apply a predetermined number of impacts corresponding to a desired applied torque.

In another aspect, the invention is a tool for applying torque to a workpiece. The tool preferably includes a fluid-driven motor; a rotationally mounted shaft; an impact mechanism coupled between the motor and the shaft for applying impacts to rotationally drive the shaft; and control means for applying a specified number of impacts to the shaft, the number of impacts corresponding to a desired torque applied to the workpiece.

In still another aspect, the invention is a tool for applying a predetermined torque to a workpiece, the tool preferably including a fluid-driven impact wrench; a database of preferred torque settings for a plurality of vehicles; and a program station for selecting one of the preferred torque settings and configuring the impact wrench to apply a torque corresponding to the selected torque setting to the workpiece.

In yet another aspect, the invention is a resonant muffler comprising a housing bounding a resonant cavity. The housing defines at least one inlet port and at least one outlet port. The at least one outlet port preferably has an acoustic baffle. The volume of the at least one outlet port is preferably about five times the volume of the at least one inlet port, and the volume of the resonant cavity is preferably an odd number multiple of the volume of the at least one inlet port.

In another aspect, the invention is a vibration damper comprising a cylindrical body and at least one resonant member coupled to the body and tuned to vibration of a specified frequency.

Among the several features, objects, and advantages of various preferred and example embodiments of the present invention are the provision of an improved fluid powered torque-applying tool of portable character, which:

Provides a method and means for applying a desired torque to fasteners, such as, i.e., Automobile and light truck wheel lug nuts;

Is simple in its design thereby promoting lower cost in mass production, and improving accessibility of this technology to the general workplace;

Improves upon and obviates the need for present methods and devices that are less desirable in terms of efficiency and accuracy;

Provides accurate and repeatable torque results;

Is robust and durable to meet the rigorous demands of daily use;

Does not require a direct torque reaction and measurement transducer but is instead able to determine torque indirectly by controlling the variable forces in the torque equation;

Has relatively low power requirements in which common battery sources may be used to provide needed power for all tool controls;

Is of portable character without the need for remote located devices and umbilical cord attachments;

Can be conveniently retrofitted into existing tools and equipment; a Can be calibrated periodically and as desired by the operator;

Can be operated within a wide range of torque application; and/or

Is easy to operate and maintain.

Additional objects and advantages of example embodiments of the invention are to provide:

A method and means to reduce the potential for human error and undetected equipment malfunction that can negatively affect a desired fastener torque result; and/or

A method and means for detecting these negative effects and errors, and alerting the operator to such errors.

Still further objects and advantages will become apparent from a consideration of the ensuing description and accompanying drawings. Of course, it will be understood that any particular embodiment of the invention may or may not necessarily embody all of these features, objects and advantages.

### BRIEF DESCRIPTION OF THE DRAWING FIGURES

In the drawings, closely related figures and reference numerals have the same number but different alphabetic suffixes. Corresponding reference numerals indicate corresponding parts throughout the drawings. For ease of identification, and where possible, reference numerals chosen for major assembly parts begin at hundreds place multiples with related subparts having the same hundreds place numeral.

FIG. 1A is a bottom view of the preferred embodiment impact wrench.

FIG. 1B is a sectioned, left side view of FIG. 1A.

FIG. 1C is a left side view of FIG. 1A.

FIG. 1D is a rear view of FIG. 1A.

FIG. 2 is an exploded view detail of an impact clutch mechanism of FIG. 1B.

FIG. 3A is a section view of an air valve assembly and a trigger assembly of FIG. 1B shown with the trigger released and air valve closed and therefore the tool is turned off.

FIG. 3B is the same as FIG. 3A with the trigger depressed and air valve open.

FIG. 3C is the same as FIG. 3A with the trigger depressed and air valve closed.

FIG. 4 is a section view of a trigger assembly alternate embodiment.

FIG. 5A is a rear perspective view of a program station.

FIG. 5b is a front perspective view of FIG. 5A.

FIG. 6 is a logic diagram of a process control electronics.

FIG. 7 is a flow diagram of a program station operating instructions.

FIG. 8A is a flow diagram of an impact wrench operating program.

FIG. 8B is a waveform illustration of an optical impact control process.

FIG. 8C is a waveform illustration of a piezoresistive transducer control process.

FIG. 8D is a view of waveform FIG. 8C illustrating the parametric envelope analysis of a waveform.

FIG. 8E is a view of waveform FIG. 8C illustrating an additional method of parametric envelope analysis.

FIG. 9A is an electronic schematic of a signal conditioning and amplifier circuit.

FIG. 9B is an exploded view of a transducer.

FIG. 9C is an assembled view, in cross section, of FIG. 9B.

FIG. 10 is a section view of a resonant muffler.

FIG. 11A is a cross section view of an air regulator.

FIG. 11B is a view similar to FIG. 11A but FIG. 11B shows a piston member and other parts in the position for valve closure.

FIG. 12A is a section view of a mechanical preload torque clutch in side view.

FIG. 12B is the same as FIG. 12A but is from a top view perspective.

FIG. 13 is a perspective view of a vibration damper

Index of Reference Numerals

| Part # | Part Name | Fig. Ref. |
|---|---|---|
| 22 | Aural Alarm | 1D |
| 24 | IR Port | 1D |
| 26 | Manual Bypass Switch | 1D |
| 28 | Visual Alarm LED | 1D |
| 30 | Impact Wrench | 1C |
| 31 | Air Regulator | 1C |
| 32 | Air Hose | 1C |
| 34 | Program Station | 5A, 5B |
| 36 | I/O Port | 5A |
| 38 | Display | 5B |
| 40 | Menu Select Up | 5B |
| 42 | Menu Select Enter | 5B |
| 44 | Menu Select Down | 5B |
| 46 | Send Program | 5B |
| 48 | I/R port | 5B |
| 50 | Flow Chart Block | 7 |
| 52 | Flow Chart Block | 7 |
| 54 | Flow Chart Block | 7 |
| 56 | Flow Chart Block | 7 |
| 58 | Flow Chart Block | 7 |
| 60 | Flow Chart Block | 8A |
| 62 | Flow Chart Block | 8A |
| 64 | Flow Chart Block | 8A |
| 66 | Flow Chart Block | 8A |
| 68 | Flow Chart Block | 8A |
| 70 | Flow Chart Block | 8A |
| 72 | Flow Chart Block | 8A |
| 74 | Flow Chart Block | 8A |
| 76 | Flow Chart Block | 8A |
| 78 | Flow Chart Block | 8A |
| 80 | Flow Chart Block | 8A |
| 82 | Flow Chart Block | 8A |
| 84 | Flow Chart Block | 8A |
| 86 | Flow Chart Block | 8A |
| 90 | Flow Chart Block | 8A |
| 92 | Flow Chart Block | 8A |
| 94 | Flow Chart Block | 8A |
| 96 | Flow Chart Block | 8A |
| 100 | Impact Housing Assembly | 1A |
| 102 | Flow Chart Block | 8A |
| 104 | Flow Chart Block | 8A |
| 105 | Oil Seal | 1B |
| 110 | Hammer Cage | 1B |
| 115 | Anvil Bushing | 1B |
| 120 | Thrust Bearing | 1B |
| 125 | Gland Seal | 1B |
| 130 | Motor Clamp Washer | 1B |
| 135 | Screw | 1B |
| 140 | Gasket | 1B |
| 142 | Vibration Damper | 13 |
| 144 | Supporting Member | 13 |
| 146 | Sine Resonant member | 13 |
| 150 | Air Regulator | 11A, 11B |
| 152 | Regulated Air Output Passage | 11A, 11B |
| 154 | Unregulated Air Input Passage | 11A, 11B |
| 156 | Piston | 11A, 11B |
| 158 | Gland Seal | 11A, 11B |
| 160 | Spring | 11A, 11B |
| 162 | Gasket | 11A, 11B |
| 164 | Valve Body | 11A, 11B |
| 166 | Valve Seat | 11A, 11B |
| 168 | Gasket | 11A, 11B |
| 170 | Pin | 11A, 11B |
| 172 | Socket | 11A, 11B |
| 174 | Seat Retainer and Pressure Adjustment | 11A, 11B |
| | Component | |
| 176 | Valve Body Retainer Component | 11A, 11B |
| 178 | Spanner Wrench Receptacle | 11A, 11B |
| 180 | Thread Sealing and Locking Compound | 11A, 11B |
| 182 | Gland Seal | 11A, 11B |
| 184 | Flow Passage | 11A, 11B |
| 186 | Gland Seal | 11A, 11B |
| 188 | Spring Seat | 11A, 11B |
| 190 | Annular Piston Seal Surface | 11A, 11B |
| 192 | Regulated Air Flow | 11A, 11B |
| 194 | Unregulated Air Flow | 11A, 11B |
| 196 | Air Bleed Hole | 11A, 11B |
| 200 | Impact Clutch Assembly | 1B |
| 205 | Hammer Cage | 1B, 2 |
| 210 | Cam Ball | 1B, 2 |
| 215 | Drive Cam Base | 1B, 2 |
| 220 | Drive Cam | 1B, 2 |
| 225 | Count Shaft | 1B, 2 |
| 230 | Locking Pin | 1B, 2 |
| 235 | Spring | 1B, 2 |
| 240 | Anvil | 1B, 2 |
| 245 | Socket Retainer Ring | 1B |
| 250 | Hammer Pin | 1B |
| 260 | Solenoid (500) Operation Driven By Signal | 8B, 8C |
| | (882) Waveform | |
| 262 | Impact Count Signal (880) Waveform | 8B |
| 263A | Impact Count Pulses | 8B |
| 263B | Trigger Switch On-State | 8B |
| 264 | Trigger Switch (845) Operation Driven By | 8B |
| | Signal (884) Waveform | |
| 265 | Parametric Envelope | 8D, 8E |
| 266 | Air Valve (400) Operation Waveform | 8B, 8C |
| 268 | Transducer (900) Operation Waveform | 8C |
| 269A | Impact Count Pulses | 8C |
| 269B | Pulse Signal Sample Point | 8C |
| 269C | Pressure Signal Sample Point | 8C |
| 300 | Trigger Assembly | 1A, 1B |
| 305 | Trigger Body | 1B, 3A, 3B, 3C, 4 |
| 310 | Trigger Load Screw | 1B, 3A, 3B, 3C, 4 |
| 315 | Spring | 1B, 3A, 3B, 3C, 4 |
| 320 | Lock Ball | 1B, 3A, 3B, 3C |
| 325 | Spring | 1B, 3A, 3B, 3C, 4 |
| 330 | Trigger Latch | 1B, 3A, 3B, 3C, 4 |
| 335 | Trigger Release | 1B, 3A, 3B, 3C, 4 |
| 340 | Trigger Pin | 1B, 3A, 3B, 3C, 4 |
| 400 | Air Valve Assembly | 1A, 1B |
| 405 | Valve Rod | 1B, 3A, 3B, 3C, 4 |
| 410 | Valve Seat | 1B, 3A, 3B, 3C, 4 |
| 415 | Gland Seal | 1B, 3A, 3B, 3C, 4 |
| 420 | Valve Seal Bushing | 1B, 3A, 3B, 3C, 4 |
| 425 | Valve Seal Spring | 1B, 3A, 3B, 3C, 4 |
| 430 | Air Inlet W/ Screen | 1B, 3A, 3B, 3C, 4 |
| 500 | Solenoid Assembly | 1A, 1B |
| 505 | Trigger Release | 1B, 3A, 3B, 3C |
| 510 | Trigger Release Ball | 1B, 3A, 3B, 3C |
| 515 | Release Bias Spring | 1B, 3A, 3B, 3C |
| 520 | Solenoid Plunger | 1B, 3A, 3B, 3C, 4 |
| 525 | Contact Ring Assembly | 1B, 3A, 3B, 3C |
| 530 | Mounting Section | 1B, 3A, 3B, 3C, 4 |
| 535 | Magnet Wire Spool | 1B, 3A, 3B, 3C, 4 |
| 545 | Cover Tube | 1B, 3A, 3B, 3C, 4 |
| 550 | End Cap | 1B, 3A, 3B, 3C, 4 |
| 555 | Pin | 4 |
| 560 | Bushing | 4 |
| 565 | Spring Compression Sleeve | 4 |
| 570 | Pin | 4 |
| 575 | Spring | 4 |
| 580 | Ball | 4 |
| 585 | Ball | 4 |
| 590 | Spring | 4 |
| 595 | Spring | 4 |
| 600 | Air Motor Assembly | 1B |
| 605 | Gland Seal | 1B |
| 610 | Front End Plate | 1B |
| 615 | Front Bearing | 1B |
| 620 | Front Seal | 1B |
| 625 | Rotor Blade | 1B |
| 630 | Cylinder Dowel | 1B |
| 635 | Cylinder | 1B |
| 640 | Rotor | 1B |
| 645 | Rear End Plate | 1B |
| 650 | Rear Gasket | 1B |
| 655 | Rear Seal | 1B |
| 660 | Rear Bearing | 1B |
| 700 | Main Housing Assembly | 1A |
| 705 | Main Housing | 1B, 11A, 11B |
| 710 | Reverse Valve Bushing | 1B |
| 715 | Reverse Valve | 1A |
| 720 | Screw Plug | 1B |
| 725 | Reverse Valve Knob | 1A |
| 730 | Reverse Valve Knob Screw | 1A |
| 735 | Reverse Valve Seal | 1B |
| 800 | Electronics | 1A, 1B |
| 805 | Gland Seal | 1B |
| 810 | Optics Cap | 1B |
| 815 | Optics Housing | 1B |
| 820 | Optic Switch Assembly | 1B |
| 825 | 9v Battery | 1B |
| 830 | Control Board | 1B |
| 835 | Electronics End Cap | 1B |
| 840 | Battery Access Latch | 1A, 1C |
| 845 | Switch | 1B |
| 850 | Nonvolatile Memory | 6 |
| 852 | Battery Circuit | 6 |
| 868 | Microprocessor | 6 |
| 869 | Infrared Link | 6 |
| 872 | Battery Circuit | 6 |
| 880 | Impact Count Signal | 6 |
| 886 | Microprocessor | 6 |
| 888 | Preload Switch | 6 |
| 900 | Transducer | 9B, 9C |
| 902 | Signal Conditioning and Amplification | 9A |
| | Circuit | |
| 904 | Output Signal | 9A |
| 905 | Impact Sensitivity Adjustment Screw | 9B, 9C |
| 910 | Housing | 9B, 9C |
| 915 | Spring | 9B, 9C |
| 920 | Ball | 9B, 9C |
| 925 | Retainer | 9B, 9C |
| 930 | Diaphragm | 9A, 9B, 9C |
| 935 | Gland Seal | 9B, 9C |
| 940 | Pressure Port | 9C |
| 950 | Resonant Muffler | 10 |
| 952A | Air Motor Exhaust Port | 10 |
| 952B | Air Motor Exhaust Port | 10 |
| 952C | Air Motor Exhaust Port | 10 |
| 954 | Muffler Exhaust Port | 10 |
| 956 | Acoustic Baffle | 10 |
| 958 | Resonant Cavity | 10 |
| 960 | Housing | 10 |
| 984 | Preload Torque Clutch | 12A, 12B |
| 985 | Anvil | 12A, 12B |
| 986 | Bushing | 12A, 12B |
| 987 | Thrust Washer | 12A, 12B |
| 988 | Spring | 12A, 12B |
| 989 | Anvil Friction Plate | 12A, 12B |
| 990 | Pin Retainer Cap | 12A, 12B |
| 991 | Clutch Spring | 12A, 12B |
| 992 | Friction Plate | 12A, 12B |
| 993 | Friction Disk | 12A, 12B |
| 994 | Hammer | 12A, 12B |
| 995 | Impact Cage | 12A, 12B |
| 996 | Pin | 12A, 12B |
| 997 | Counting Pin | 12A, 12B |
| 998 | Clutch Housing | 12A, 12B |
| 999 | Cam Face | 12A, 12B |

### DETAILED DESCRIPTION OF PREFERRED EMBODIMENTS

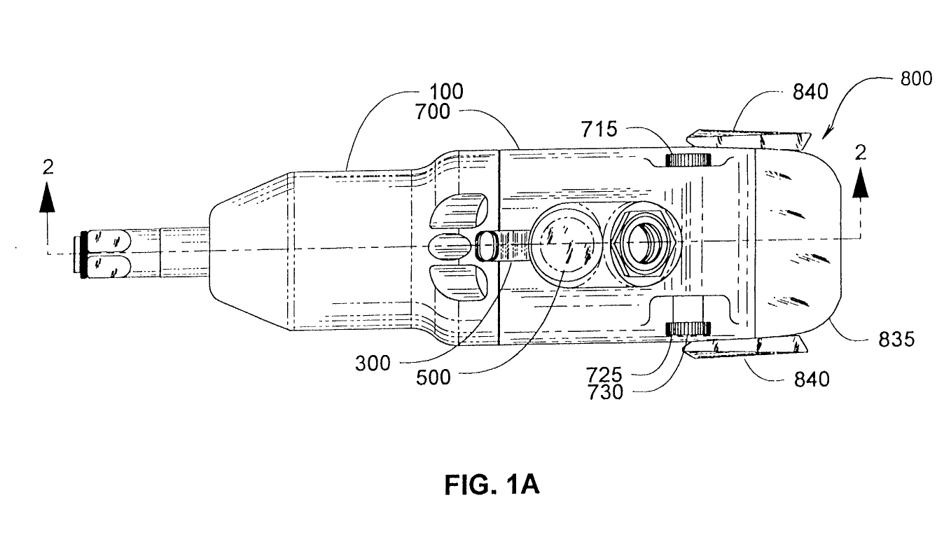

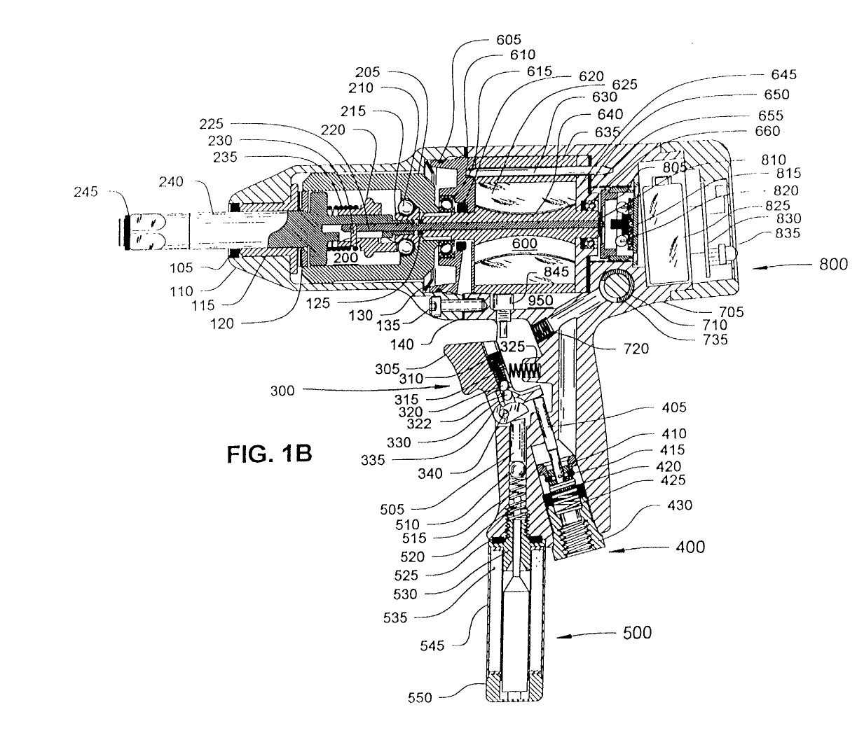

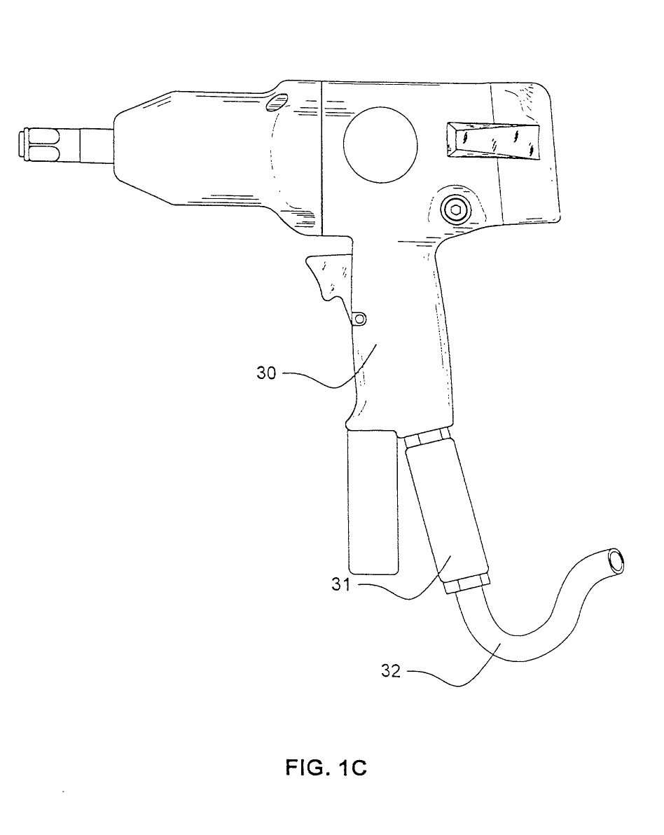

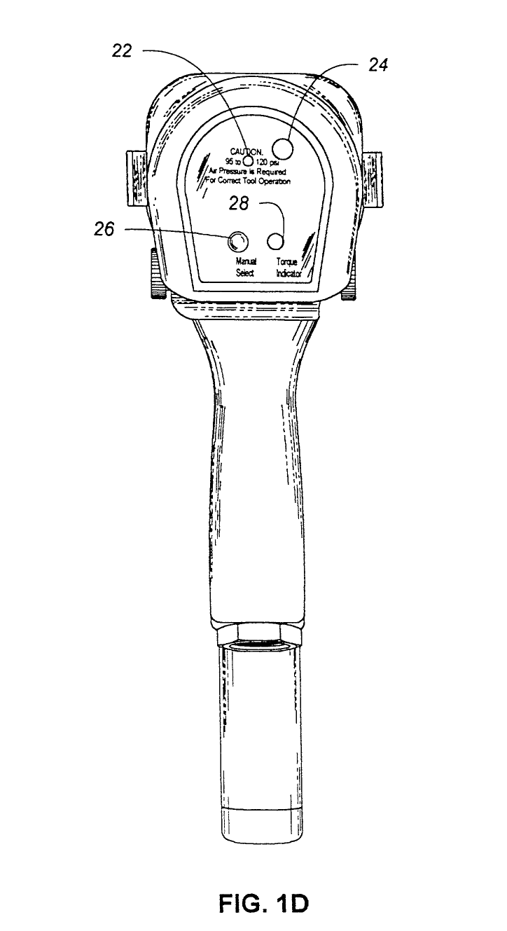

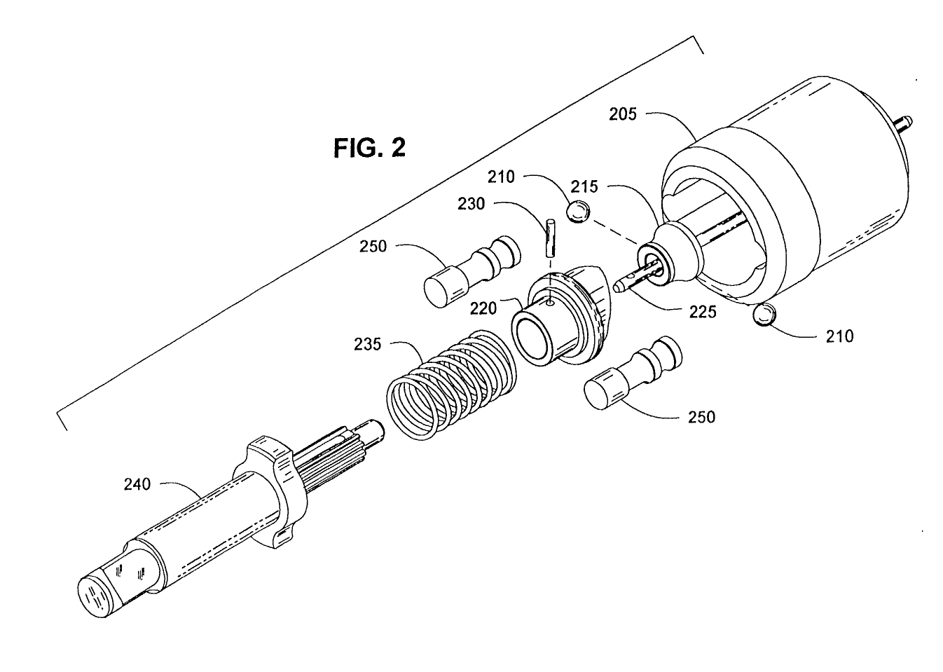

FIG. 1A to FIG. 1D, FIG. 2, FIG. 10—Preferred Embodiment Impact Wrench

A preferred embodiment of one aspect of the present invention is illustrated in FIG. 1A (bottom view), FIG. 1B (left side section view), FIG. 1C (left side view), FIG. 1D, (rear view), and FIG. 2 (exploded view of an impact clutch assembly 200 of FIG. 1B). This preferred embodiment of the method and apparatus of this invention illustrates the conversion of an existing, off-the-shelf, impact wrench to one having torque setting and torque controlling capability.

FIG. 1A is illustrated without an air regulator 31 installed to more clearly illustrate other features of impact wrench 30. A trigger assembly 300 and a reverse valve 715, with a reverse valve knob 725 retained by a screw 730, are the manual operating controls of the tool. Electronics 800 are housed inside an electronics end cap 835 which is retained to a main housing 700 by means of two battery access latches 840. An impact housing assembly 100 is attached to a main housing 700 by screws 135 (as shown in FIG. 1B) to provide support and maintenance access for the internal components. A solenoid 500 is shown in its relation to a trigger assembly 300.

FIG. 1B is a section view of FIG. 1A. An impact housing assembly 100 is comprised of an oil seal 105, a hammer cage 110, an anvil bushing 115, a thrust bearing 120, a gland seal 125, a motor clamp washer 130, a screw 135, and a gasket 140.

An impact clutch assembly 200 is comprised of a hammer cage 205, cam balls 215, a drive cam 220, a count shaft 225, a locking pin 230, a spring 235, an anvil 240 with a socket retainer ring 245, a hammer pin 250 (shown in FIG. 2).

A trigger assembly 300 is comprised of a trigger body 305, a trigger load screw 310, a spring 315, a trigger latch 330, a trigger release 335, a trigger pin 340.

An air valve assembly 400, is comprised of a valve rod 405, a valve seat 410, a gland seal 415, a valve seal bushing 420, a valve seal spring 425, an air inlet with screen 430.

A solenoid assembly 500 comprised of a trigger release 505, trigger release ball 510, a release bias spring 515, a solenoid plunger 520, a contact ring assembly 525, a mounting section 530, a magnet wire spool 535, a cover tube 545, an end cap 550.

An air motor assembly 600 comprised of a gland seal 605, a front end plate 610 a front bearing 615, a front seal 620, a plurality of rotor blades 625, a cylinder dowel 630, a cylinder 635, a rotor 640, a rear end plate 645, a rear gasket 650, a rear seal 655, a rear bearing 660.

Main housing assembly 700 is comprised of a main housing 705 which provides the supporting frame for impact wrench 30 as well as other parts including a reverse valve bushing 710, reverse valve, 715, screw plug 720, reverse valve knob 725, screw 730, and two reverse valve seals 735. Electronics 800, include a gland seal 805, an optics cap 810, an optics housing 815, an optic switch assembly 820, a 9v battery 825, a control board 830, a electronics end cap 835. A switch 845, is located in proximity to and operated by trigger assembly 300. A resonant muffler 950 is illustrated and more thoroughly detailed in FIG. 10.

FIG. 1C shows the impact wrench 30 set up requirements for normal operation with an attached air regulator 31 and supplied by continuous source of pressurized air through an air hose 32.

FIG. 1D shows the rear view of impact wrench 30 and illustrates the controls for electronics 800, specifically an aural alarm piezoelectric transducer 22, an IR port 24 infrared signal receiving transistor, a manual bypass switch 26 momentary on push-button switch, and a visual alarm red/green LED 28. These components provide the tool user with electronic process controls of impact wrench 30.

FIG. 2 is an exploded view of impact clutch assembly 200 of FIG. 1B to clearly show a hammer pin 250 and its relation to other parts.

Referring to FIG. 10, muffler 950 of FIG. 1B is shown in section side view. A resonant cavity 958 is contained within a housing 960 and having a plurality of air motor exhaust ports 952A through 952C and has a muffler exhaust port 954 that is acoustically sealed with acoustic baffle 956 of non-woven material. In theory of operation, it is the discovery of this invention that given a measured volume of air motor exhaust ports 952A-952C, herein designated as the total volume “V,” and a given volume of muffler exhaust port 954, filled with acoustic baffle 956, equal to five (5) times V, then a volume of resonant cavity 958 can be specified to provide a pleasant exhaust sound with reduced noise level output resulting from the muffler. Applicant has discovered that a volume of resonant cavity 958 that is an odd number multiple, and more preferably a prime number multiple, of the volume V, most preferably a multiple of 11 or greater, will convert objectionable and unpleasant sound frequency output to a pleasant, lower pitch, sound frequency with the added benefit that the frequency conversion process is not efficient and a measurable portion of the sound energy is lost in the form of heat to be absorbed by housing 960. Moreover, resonant muffler 950 causes a minimum restriction to exhaust flow. The muffler of the present invention is adaptable for use with a variety of fluid-driven tools, and can also be used in virtually any other application where noise reduction and/or sound frequency modification is desired. For example, the muffler of the present invention is applicable to use as an automotive exhaust muffler.

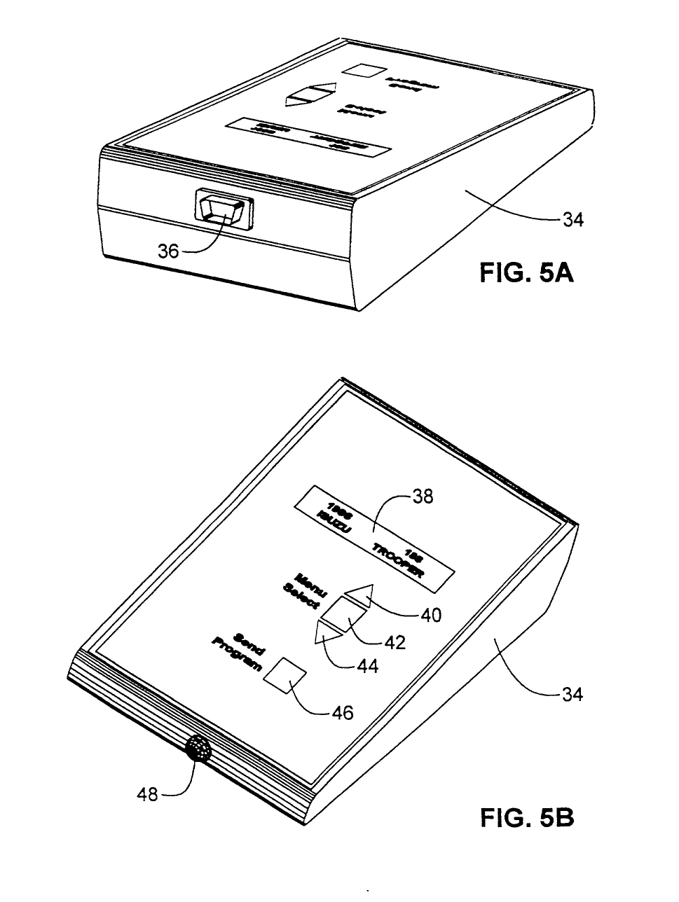

FIGS. 5A and 5B—Preferred Embodiment Program Station

Referring to FIG. 5A, a program station 34 is designated in its entirety. An l/O port 36 is a common variety DB-9 connector and provides a data update access means at the rear of program station 34.

FIG. 5B illustrates the more common front perspective view an operator would have when operating the controls of program station 34. A display 38 can be readily viewed when depressing a menu select up 40, a menu select enter 42, a menu select down 44, or a send program 46 keypad membrane button switch. An l/R port 48 is a typical infrared LED which provides a program transmission means for transferring the menu selected information from program station 34 to impact wrench 30 via l/R port 24.

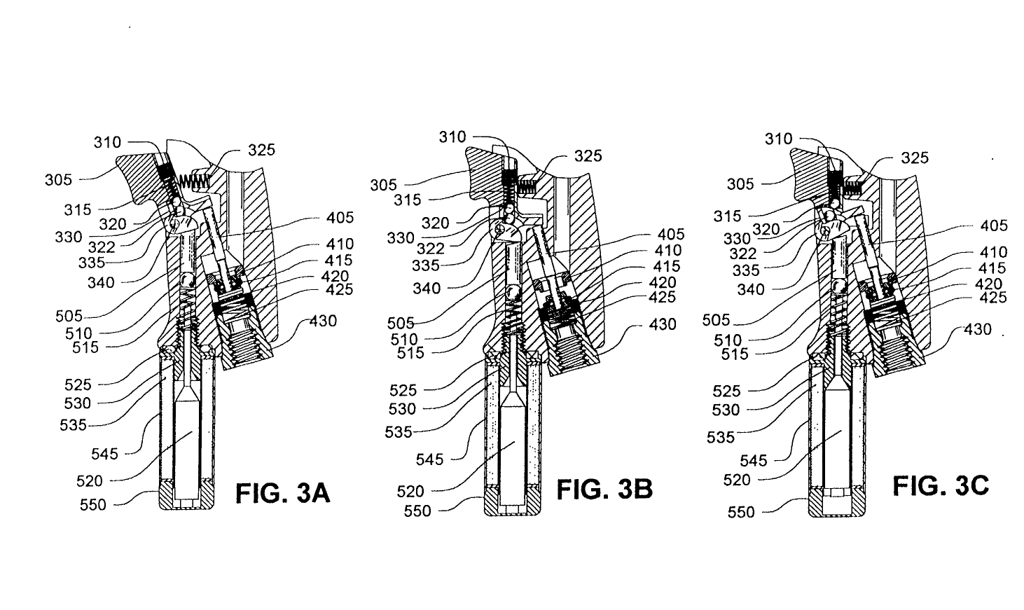

FIGS. 3A to 3C and FIG. 6 to FIG. 8B—Preferred Embodiment Description of Operation

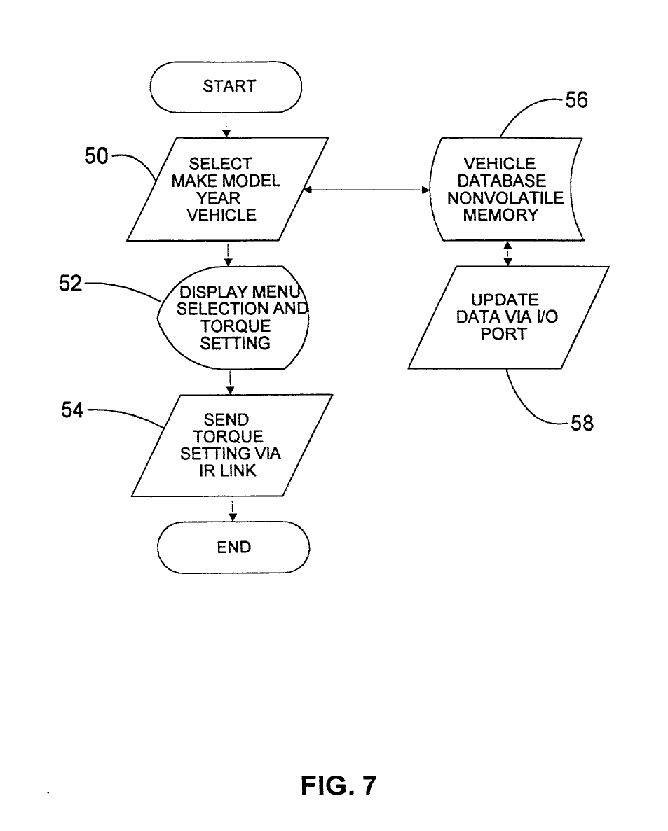

As more fully explained below, a user of impact wrench 30 selects a preprogrammed tool setting from a database of applications contained in program station 34 by using the menu selection features of program station 34 and presses send program 46 to transmit the tool setting to impact wrench 30 (FIG. 7). Once programmed, Impact wrench 30 will provide a reliable and consistent torque process event with a correct final torque value for the selected application. In a preferred form of the invention, a look-up table contains known torque settings for all makes and models of vehicles expected to be encountered. A relational database relates the operator input to a specified one of the known torque settings.

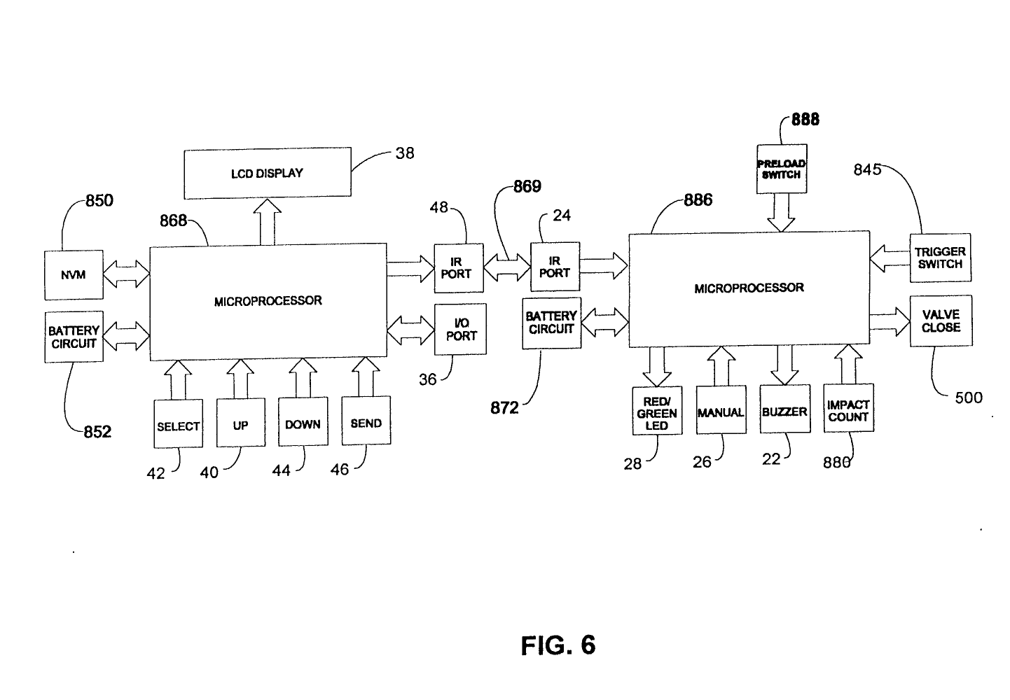

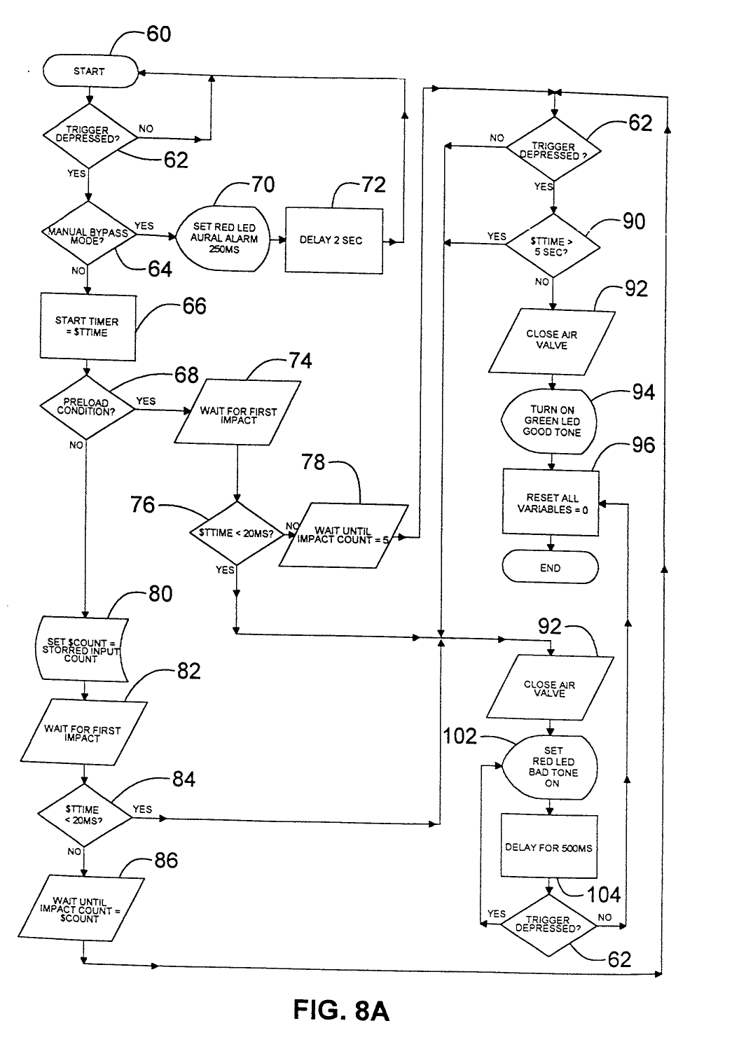

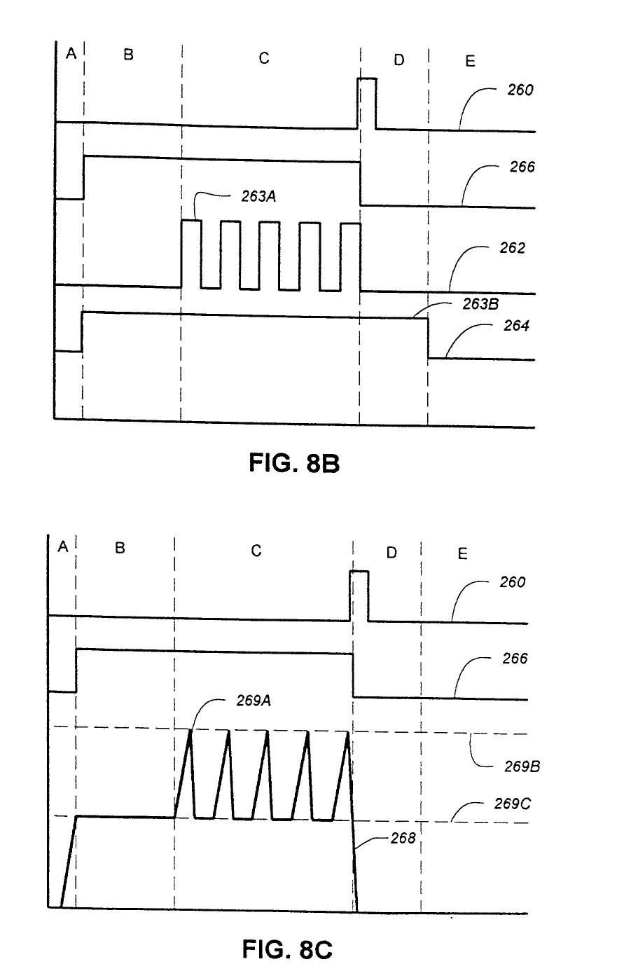

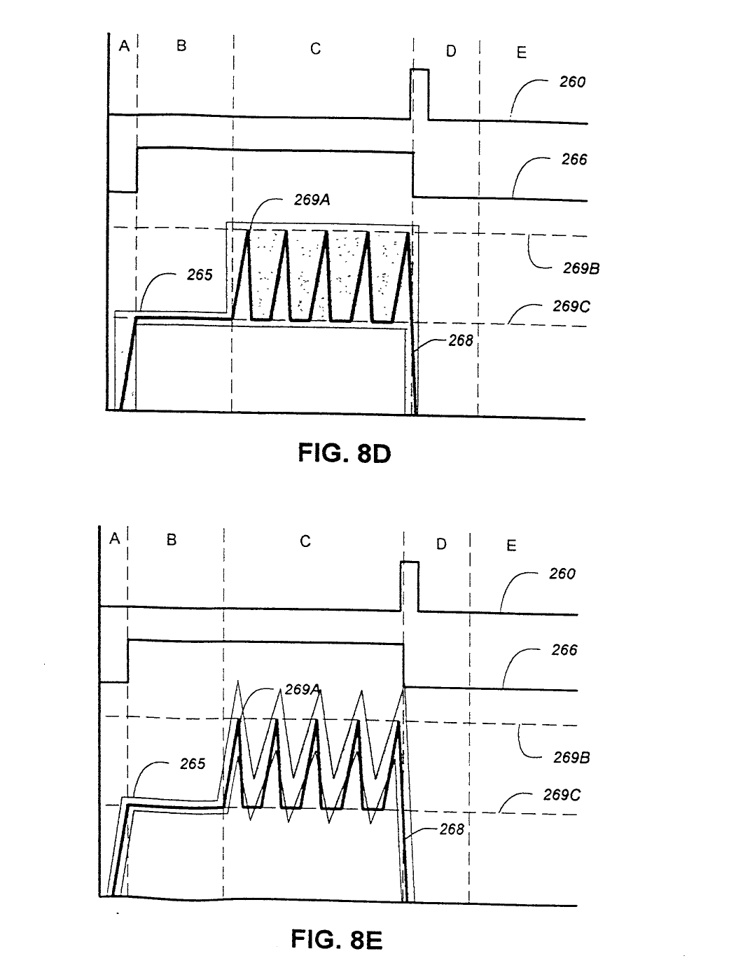

FIG. 6 most clearly illustrates the process control electronics contained within impact wrench 30 and program station 34. A microprocessor 868 is contained within program station 34 and is powered by a battery circuit 852. A nonvolatile memory 850 contains a database of tool settings that is called up by microprocessor 868 by means of menu selection using the keypad buttons 40, 42, 44, 46 and the results of that selection viewable at display 38. I/O port 36 is provided for update access of nonvolatile memory 850. Upon depressing send 46, microprocessor 868 transmits the tool setting through IR port 48 by means of infrared link 869 to IR port 24 of tool 30. A microprocessor 886 is housed within impact wrench 30 and part of electronics 800. A battery circuit 872 provides power to microprocessor 886. Trigger switch 845, solenoid 500, LED 28, manual bypass 26, aural alarm 22 are directly controlled by, or provide controls to, microprocessor 886 as illustrated by the flow diagram arrows (FIG. 8). An impact count 880 from optic switch 820 (FIG. 1B) provides impact counting information to microprocessor 886. A preload switch 888 sets the microprocessor for initial fastener preload torque.

Referring to FIG. 7, Program station 34 is operated by viewing display 38, shown as a logic block 52, while using menu select 40, 42, 44 to select make model year vehicle, shown as a logic block 50, and transmit the correct nonvolatile memory 850, shown as a logic block 56, tool setting to impact wrench 30, as shown in a logic block 54. I/O port 36 provides the means for updating nonvolatile memory 850, as shown in a logic block 58.

Once the tool setting is downloaded into impact wrench 30 the tool can be used to tighten a wheel lug nut fastener for a known application by make, model, and year of vehicle. Rather than directly measuring and controlling applied torque, the present invention senses and counts the number of impacts applied by the tool to the workpiece, and relates the number of impacts to an inferred resultant final torque. The present invention controls the final applied torque by controlling the number of impacts applied. The number of impact counts corresponding to a desired final fastener torque setting for each intended make and model of vehicle is empirically or otherwise determined, and is stored in the database. An initial pre-torque is applied during a fastener run-down step, thereby establishing a consistent known starting point for final torque process control. The mechanical features of the clutch mechanism, described in greater detail herein, establish the predetermined initial torque setting.

In a first preferred embodiment of the invention, the count shaft 225 reciprocates back and forth in an axial direction with rotation of the hammer cage 205 to generate the impact “counts” utilized to infer the applied torque. For example, the count shaft 225 preferably reciprocates a predetermined number of times for each rotation of the hammer cage, whereby the number of times the shaft reciprocates is directly proportional to the number of impacts applied to the workpiece. The optic switch 820 is positioned to sense each reciprocation of the count shaft, thereby enabling counting of the number of reciprocations of the shaft.

FIG. 8B illustrates the sequence of events during the fastener run down and final torque process. The waveform period A occurs when the tool is not operating. Period B begins when trigger assembly 300 is depressed, closing switch 845 to produce signal 264 which microprocessor 886 uses to produce signal 266 representing the operation of air valve assembly 400 and, thus, period B represents the fastener run down period. Period C is the tightening period during which time the workpiece is being torqued for the programmed torque setting of number of counts, shown by a signal 262 the number of which is selected by program station 34. Period D is initiated by microprocessor 886 which sends signal 260 to solenoid 500 thereby closing air valve assembly 400 and indicated by the drop of signal 266. Period E begins upon the release of trigger assembly 300 by the operator as shown by the down transition of signal 264 and the reset of impact wrench 30 to the not operating state of period A.

FIG. 8A is a flow diagram of the process control program of impact wrench 30. The events of FIG. 8B occur as a direct result of logic control by microprocessor 886 as determined by the preprogrammed decisions and flow of blocks 60 through 104 of FIG. 8A.

FIGS. 3A through 3C illustrate the automatic tool shut off parts and principles involved to affect the use of signal 260 to shut off the tool illustrated by signal 266 at period D of FIG. 8B. FIG. 3A illustrates the configuration of all parts during period A and after period E of FIG. 8B. As trigger assembly 300 is depressed (FIG. 3B) air valve assembly 400 is opened to permit the compressed air into air motor 600 and beginning fastener rundown period B. FIG. 3C, at the beginning of period D (FIG. 8B) shows all parts in position as the generation of signal 260 produces an electric charge of magnet wire spool 535 and drives solenoid plunger 520 into ball 510, trigger release 505, and trigger release 335. The subsequent rotation of trigger release 335 on trigger pin 340 pressed ball 322 into ball 320. This action unlocks trigger latch 330 and permits the valve to close due to the internal pressure of air valve assembly 400.

This fluid valve control method and equipment configuration of the present invention is adaptable for use in applications beyond fluid powered drive tools, and may be utilized, for example, in any industrial process incorporating fluid valving for process control. The method and apparatus of this aspect of the present invention advantageously reduces electrical power consumption relative to previously known systems, as the solenoid is only activated periodically and for brief duration, rather than necessitating constant power supply to maintain a normally open valve in a closed position (or vice versa).

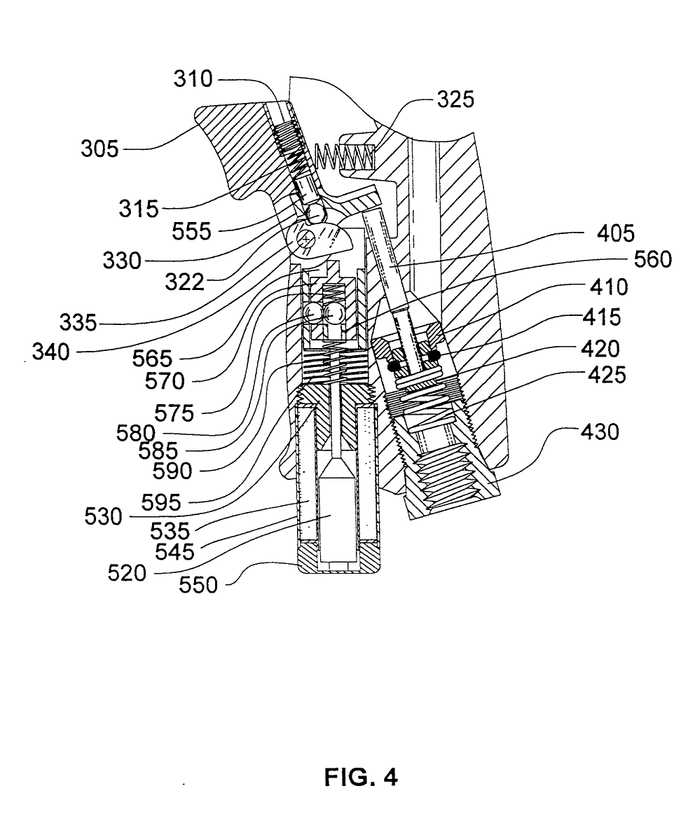

FIG. 4, FIGS. 8C to 8E, FIGS. 9A to 9C, FIGS. 11A to 12 C—Alternate and Alternative Embodiments

FIG. 4 illustrates an alternative embodiment of the components of FIGS. 3A through 3C. The substitution of a pin 555 for ball 320 can provide additional locking force, as adjustably biased by spring 315 and trigger load screw 310, between trigger body 305 and trigger latch 330. Additionally, a Spring compression sleeve 565 is pressed downward by trigger body 305 and forcing the loading of spring 590 against a pin 570. A ball 580 and a ball 585 provide a locking mechanism to retain spring compression sleeve 565 and pin 570 through means of pressure of a spring 575. Upon operation of solenoid 500, solenoid plunger 520 pushes ball 585 up and releases pin 570. Pin 570 is forced into trigger release 335 through action of spring 590. As in FIGS. 3A-C the valve assembly is closed when pin 555 is displaced out of shear between trigger body 305 and trigger latch 330.

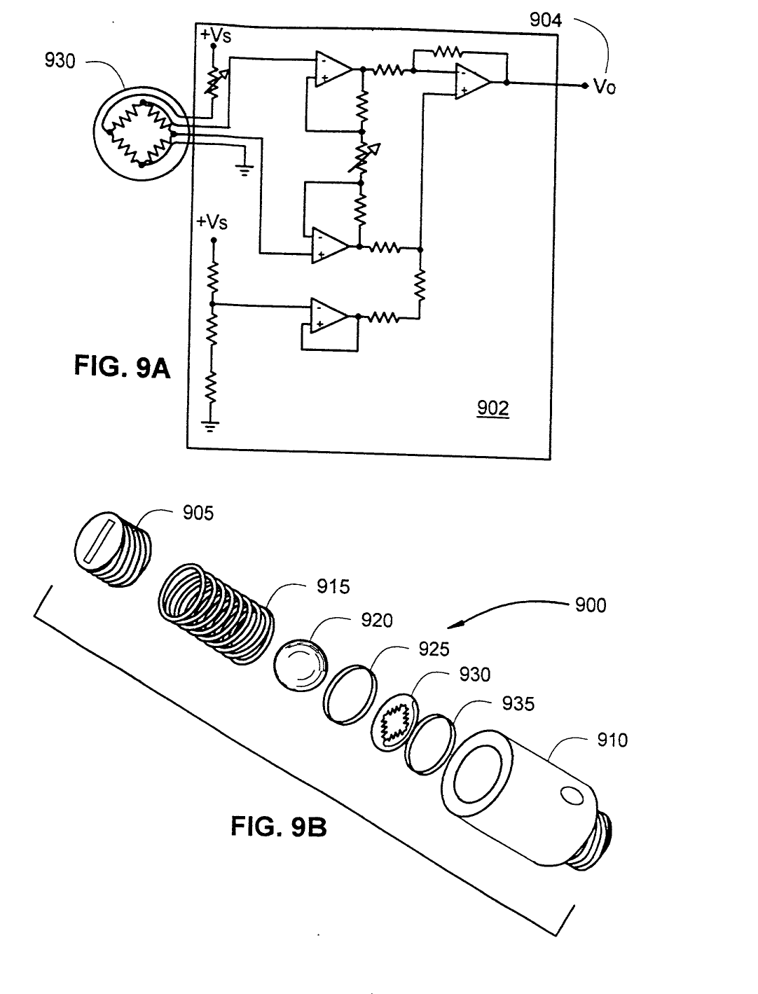

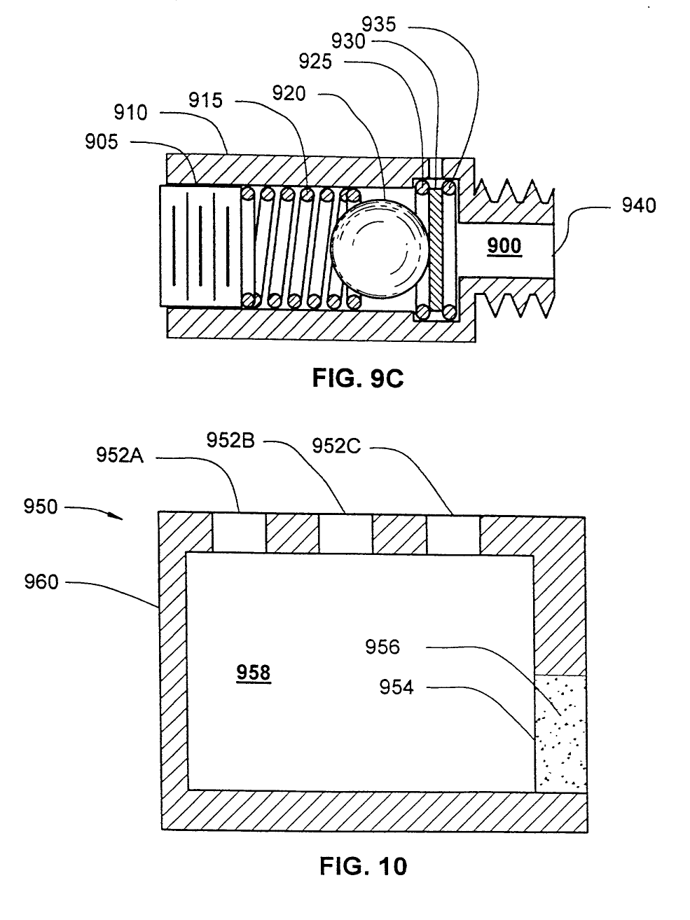

FIG. 8C is operationally identical to FIG. 8B with the following exception. A signal 268 is produced by a transducer 900 and an output signal 904 from a signal conditioning and amplifier circuit 902 (FIG. 9A) and operationally replaces both signal 262 and signal 264 of FIG. 8B. FIG. 8C illustrates the operating conditions of impact wrench 30 when a transducer 900 is used to replace switch 845 and optic switch assembly 820. Additionally, transducer 900 will obviate the need for the mechanical devices (FIG. 1B) needed to produce counting pulses 269A (FIG. 8C). FIG. 9B most completely illustrates the parts of transducer 900. Transducer 900 is fabricated from a housing 910, a gland seal 935, a diaphragm 930, a retainer 925, a ball 920, a spring 915 and an impact sensitivity adjustment screw 905.

FIG. 8D and 8E illustrates a further embodiment, wherein a parametric envelope 265 waveform is used for quality assurance and operation verification. The parametric envelope 265 is determined through sampling of known good signals 268 during an initial calibration operation. The mathematical features are extracted from the sampling data electronically via microprocessor 886 and compared in real time to follow-on operations. Through these means, a pass/fail decision can be made and the operator is alerted via buzzer 22 and red/green led 28 devices.

FIG. 9C shows a cross section side view of transducer 900. A air pressure port 940 is in communication with the air pressure region between air valve assembly 400 and air motor 600 and is sealed from atmosphere via gland seal 935 and diaphragm 930 held by retainer 925 against movement from the pressure at port 940. Diaphragm 930 is a thin metal disk with a laminated piezoelectric strain gage element on its surface. As shown in FIG. 9A, diaphragm 930 is electronically biased and monitored to produce a signal 904 during any deflection of its surface. As the pressure of port 940 increases, diaphragm 930 flexes producing a bias value of signal 268 (FIG. 8C) and a pressure signal sample point 269C (FIG. 8C). Any shock or vibration within impact wrench 30 are sensed by means of the mass of ball 920, held with a spring pressure bias force of spring 915 and impact sensitivity adjustment screw 905, bouncing on the surface of diaphragm 930. This bouncing activity is translated into a pulse signal sample point 269C (FIG. 8C) and produces the impact count pulses 269A.

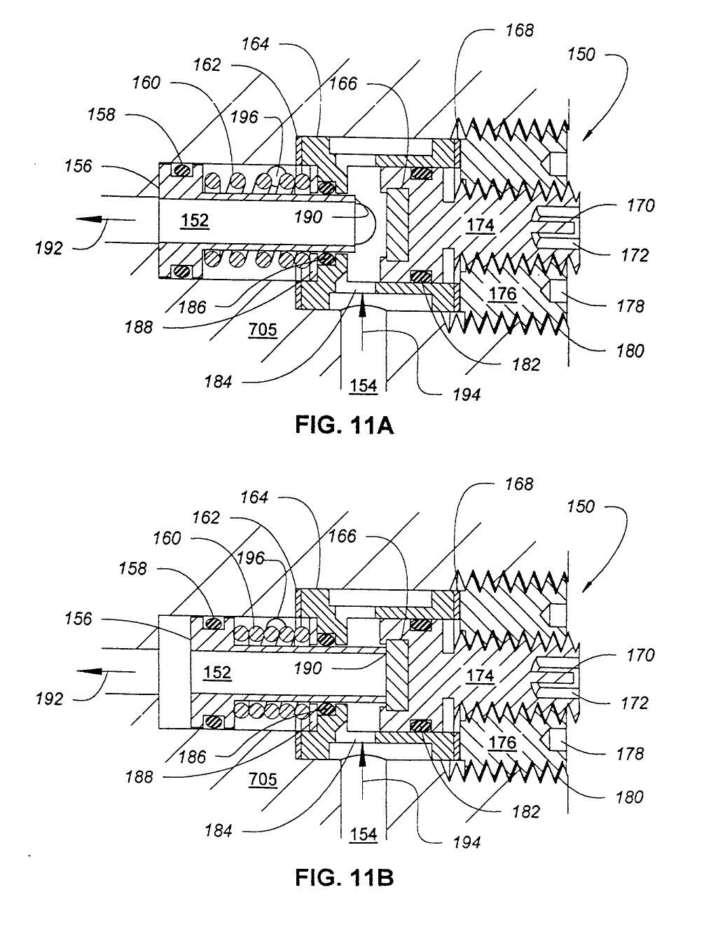

FIG. 11A and 11B illustrate an air regulator 150, shown in section side view, that may be used as an alternate embodiment of air regulator 31. Main housing 705 is machined to receive a valve body retainer component 176 by means of machine thread which is sealed with a thread sealing and locking compound 180 preferably having an anaerobic curing characteristic. The installation of valve body retainer component 176 by means of a spanner wrench receptacle 178 places a gasket 168 of paper, metal or other such typical gasket material in compression between valve body retainer component 176 and a valve body 164 which further compresses gasket 162 to the machined bottom of the recess of main housing 705. A gland seal 182, a gland seal 186, and a spring seat 188 provide sealing means to complete the pressure sealed chamber area of an unregulated air input passage 154. A seat retainer and pressure adjustment component 174 is adjustably attached within the internal threaded opening of a valve body retainer component 176 and a valve seat 166 is fixedly attached by way of coin edge material roll-over, adhesive or other mechanical attachment means. Seat retainer and pressure adjustment component 174 is fashioned with a pin-in-socket 172 tool access point wherein a pin 170 is fabricated into the socket as an integral part thereof as a means for tamper resistance of the adjustment setting. Valve seat 166 is fabricated from an elastomeric compound such as Nitrile, Neoprene, Fluorocarbon, Silicone, Fluorosilicone, EPDM, Teflon, Urethane, and the like, of at least 40 durometer (Shore “A” scale) hardness to provide a sealing means at an annular piston seal surface 190 of a piston 156. Piston 156 is sealed with a gland seal 158 and gland seal 186 to provide separation between the areas of a regulated air output passage 152 and the atmosphere venting area of a bleed hole 196. Piston 156 is slidably mounted within the bore of main housing 705 and held under the tension of spring 160. An unregulated air flow 194 enters through a flow passage 184 and pressurizes regulated air passage 152 until the pressure overcomes the spring rate of spring 160 forcing piston 156 to compress against valve seal 166. The operation of piston 156 operates in a continuous motion thereby providing a regulated air flow 192. Seat retainer and pressure adjustment component 174 may be adjusted in, towards piston 156, to reduce the regulated air pressure of regulated output passage 152. It is anticipated that unregulated air flow passage 184 may be configured as illustrated or, alternately, in line by means of drilled passages through valve body retainer component 176.

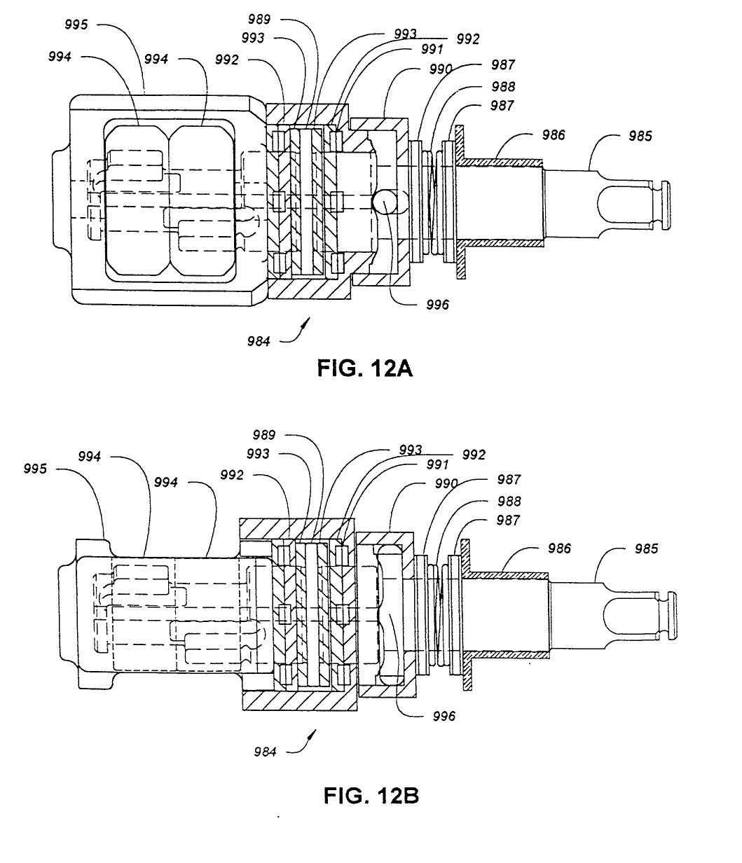

FIGS. 12A-B illustrates an alternative embodiment wherein a preload torque clutch 984 is used to produce the initial torque force on the workpiece before the count of impacts are provided to the workpiece for final torque. During period C (FIG. 8B) impact cage 995, attached in direct drive to air motor 600 by means of a shaft spline, rotates a hammer 994 which strikes an anvil 985 at one impact per revolution producing the final torque to the workpiece. During period C preload torque clutch 984 has little affect on the operation of impact wrench 30 and simply slips between anvil 985 and impact cage 995. During period B (FIG. 8B) preload torque clutch, mechanically fastened to impact cage 995 provides a friction force to anvil 985 at an anvil friction plate 989. A friction disk 993 is forced against anvil friction plate 989 by a plurality of clutch springs 991 and a friction plate 992. The force of springs 991 are selected to place a known constant pressure in the system producing a slip clutch affect between the impact cage 995 and anvil 985 with the affect that anvil 985 will turn the workpiece at a constant drive torque until torque preload clutch 984 slips. A pin 996 is located through a hollow of anvil 985 and communicates with cam surface of preload torque clutch 984. Pin 996 thus produces a linear reciprocation motion during the impact period C (FIG. 8B) and provides the linear motion needed for producing impact counts through count shaft 225 in concert with optic switch assembly 820.

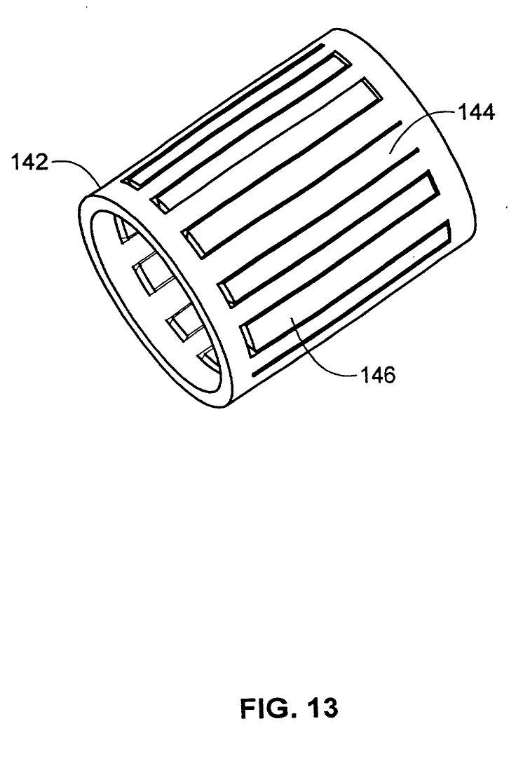

FIG. 13 is a perspective view of a vibration damper 142. A plurality of supporting members 144 supports the structure and suspends a plurality of sine resonant members 146 along the circumference of vibration damper 142. These resonant members can be “tuned” to absorb vibration of a desired frequency by selective removal of material at their root end to reduce their cross-sectional area. Vibration damper 142 is assembled into main housing assembly 700, or alternately, into impact housing assembly 100. The vibrations of air motor assembly 600 and impact clutch assembly 200 are translated into movement of sine resonant members 146, thereby transforming vibrational energy into heat. The mass resistance of sine resonant members 146 produces a damping effect on all tool produced vibrations.

Conclusion, Ramifications, and Scope

As disclosed herein, example aspects of the invention include:

a) The main embodiment discloses a rod operating in common with an impact mechanism to produce an actuation of an optical switch thereby producing the desired count of number of impacts in real time;

b) An alternate embodiment to (a) above, includes a pressure and impact count transducer device or other separate pressure and shock detecting means which produces the same desired effect;

c) An adjustable air pressure regulation means, located in close proximity to the air motor, is common to all embodiments and is used to provide tool calibration, improve accuracy and repeatability; The main embodiment discloses a commercially available, in-line, air pressure regulator, an alternate embodiment to this device is disclosed herein with many advantages over commercially available and prior art regulator devices;

d) A use of the first impact to start the torque measurement process as disclosed in the main embodiment, or

e) in an alternate embodiment to (d) above, a mechanical clutch device means presents a predetermined torque preload to the fastener and signals the control processor to begin the torque measurement process;

f) Counting the number of impacts, as disclosed in the main embodiment, from the predetermined start of the torque measurement process to determine the final torque applied to a fastener;

g) In an alternate embodiment to (f) above, the use of elapsed time measurement from the predetermined start of the torque measurement process to determine the final torque applied to a fastener;

h) The use of a preprogrammed database containing the torque settings for a known family of fasteners to establish the tool power shut off point thereby producing the desired fastener torque result;

i) In an alternate embodiment to (h) above, the use of a process record and/or manual entry method to teach and/or manually set the selected tool the shut off point; additionally, a parametric envelope waveform embodiment allows real time conditional instructions for operating the tool as well as providing pass/fail feedback to the operator and statistical information for quality assurance methodology.

j) An air valve that is integral to the tool and in close proximity to the air motor that is initially opened by manually depressing a trigger means and which is automatically closed through a powered actuator means with, as specified within the main embodiment disclosure, the use of a battery powered linear solenoid. However, other powered means, such as fluid pressure, electric power from other sources, and rotary actuator means, are obvious alternate methods;

k) An alternate embodiment to (j) above is disclosed wherein a spring loaded mass is cocked during the manual depression of the trigger means allowing for a lower powered automatic actuator means to release the potential energy of the spring and propel a mass object into an air valve release thereby automatically disconnecting the trigger link to the air valve causing the tool to be shut off.

Each aspect of the invention possesses utility, both individually and in combination with one or more other aspects of the invention. Accordingly, preferred embodiments of the invention comprise one or more of the above aspects of the invention. For example, referring to the foregoing detailed description and the drawing figures, a particularly preferred embodiment of the invention comprises a combination of features of aspects (a+c+e+f+h+i). Additional and alternate embodiments comprise combinations of the above aspects of the invention to produce numerous different tool configurations particularly suited for various applications. Examples of such alternate embodiments include combinations of the following aspects of the invention:

```
  1) a + c + e + f + h + k
  2) a + c + e + f + i + j
  3) a + c + e + f + i + k
  4) b + c + e + f + h + j
  5) b + c + e + f + h + k
  6) b + c + e + f + i + j
  7) b + c + e + f + i + k
  8) a + c + e + g + h + j
  9) a + c + e + g + h + k
10) a + c + e + g + i + j
11) a + c + e + g + i + k
12) c + b + e + g + h + j
13) c + b + e + g + h + k
14) c + b + e + g + i + j
15) c + b + e + g + i + k
16) a + c + d + f + h + j
17) a + c + d + f + h + k
18) a + c + d + f + i + j
19) a + c + d + f + i + k
20) b + c + d + f + h + j
21) b + c + d + f + h + k
22) b + c + d + f + i + j
23) b + c + d + f + i + k
24) a + c + d + g + h + j
25) a + c + d + g + h + k
26) a + c + d + g + i + j
27) a + c + d + g + i + k
28) b + c + d + g + h + j
29) b + c + d + g + h + k
30) b + c + d + g + i + j
31) b + c + d + g + i + k
```

From the above disclosed features and embodiments it can be readily seen by those skilled in the art that the ramifications of this invention allows for a multitude of tools to be constructed. For example, the torque process control method and apparatus, as herein described, will permit the design and construction of an in-line, or pistol grip configuration tool, with torque control capability and individually unique features specifically required for a desired end use such as an:

1) air powered impact wrench;

2) air powered impulse driven nut runner;

3) air powered direct drive nut runner;

4) hydraulic powered impact wrench;

5) hydraulic powered impulse driven nut runner;

6) hydraulic powered direct drive nut runner;

7) air powered impact ratchet wrench;

8) air powered impulse driven ratchet wrench;

9) air powered direct drive ratchet wrench;

10) hydraulic powered impact ratchet wrench;

11) hydraulic powered impulse driven ratchet wrench;

12) hydraulic powered direct drive ratchet wrench;

The example features and embodiments described herein can be readily adapted for use in a remote located control station to allow the control and operation of one or more tools from a distance.

While the invention has been described in its preferred forms, it will be readily apparent to those of ordinary skill in the art that many additions, modifications and deletions can be made thereto without departing from the spirit and scope of the invention.

What is claimed is:

1. A method of controlling torque applied to a workpiece by a tool, said method comprising:
(a) counting a number of impacts applied by the tool to the workpiece;
(b) controlling the number of impacts applied by the tool to the workpiece to apply a predetermined number of impacts corresponding to a desired applied torque.

2. The method of claim 1, further comprising the step of applying an initial pre-torque during a fastener run-down step.

3. The method of claim 2, wherein the initial pre-torque is applied through a clutch mechanism.

4. The method of claim 1, wherein the step of counting a number of impacts comprises optically sensing reciprocations of a reciprocating count shaft, wherein the number of impacts is directly proportional to a number of reciprocations of the count shaft.

5. The method of claim 1, wherein the step of counting a number of impacts comprises electronically sensing impacts utilizing a piezoelectric strain gage.

6. The method of claim 1, further comprising storing a plurality of preferred torque settings in a database, selecting one of said plurality of preferred torque settings, and setting the tool to apply a predetermined number of impacts corresponding to the selected torque setting.

7. The method of claim 6, wherein the step of setting the tool to apply a predetermined number of impacts corresponding to the selected torque setting comprises transmitting a signal from a program station to the tool.

8. The method of claim 1, further comprising comparing a sensed impact with a parametric envelope waveform to qualify or reject the sensed impact.

9. A tool for applying torque to a workpiece, said tool comprising:
(a) a fluid-driven motor;
(b) a rotationally mounted shaft;
(c) an impact mechanism coupled between said motor and said shaft for applying impacts to rotationally drive said shaft; and
(d) control means for applying a specified number of impacts to said shaft, the number of impacts corresponding to a desired torque to be applied to the workpiece.

10. The tool of claim 9, wherein said control means comprises a counting mechanism for counting the number of impacts applied to the shaft.

11. The tool of claim 10, wherein said counting mechanism comprises a reciprocating shaft coupled to said impact mechanism.

12. The tool of claim 11, further comprising an optical switch for sensing reciprocation of said reciprocating shaft.

13. The tool of claim 10, wherein said counting mechanism comprises an electronic impact sensor.

14. The tool of claim 9, further comprising a trigger for actuating said fluid-driven motor and a power-actuated release for de-activating said motor upon application of the specified number of impacts to said shaft.

15. The tool of claim 9, further comprising a pressure regulator for regulating fluid pressure supplied to drive said motor.

16. The tool of claim 9, further comprising a program station for setting the tool to apply a specified number of impacts to said shaft.

17. The tool of claim 16, wherein said program station comprises a display for identifying a torque setting.

18. The tool of claim 9, wherein said control means comprises a database of preferred torque settings.

19. The tool of claim 9, further comprising a vibration damper comprising a cylindrical body having at least one resonant member tuned to vibration of a specified frequency.

20. The tool of claim 9, further comprising a clutch for applying an initial pre-torque to the fastener.

21. The tool of claim 9, further comprising a resonant muffler.

22. A tool for applying a predetermined torque to a workpiece, said tool comprising:
(a) a fluid-driven impact wrench;
(b) a database of preferred torque settings for a plurality of vehicles; and
(c) a program station for selecting one of said preferred torque settings and configuring said impact wrench to apply a torque corresponding to the selected torque setting to the workpiece.

23. The tool of claim 22, wherein said database of preferred torque settings comprises data identifying a number of impacts to be applied by said fluid-driven impact wrench to apply the selected torque to the workpiece.

24. A resonant muffler comprising a housing bounding a resonant cavity, said housing defining at least one inlet port and at least one outlet port, said at least one outlet port having an acoustic baffle, wherein the volume of said at least one outlet port is about five times the volume of said at least one inlet port, and the volume of said resonant cavity is an odd number multiple of the volume of said at least one inlet port.

25. The resonant muffler of claim 24, wherein the volume of said resonant cavity is a prime number multiple of the volume of said at least one inlet port.

26. A vibration damper comprising a cylindrical body and at least one resonant member coupled to said body and tuned to vibration of a specified frequency.

27. A kit for providing torque control to a fluid driven impact wrench, the kit comprising a counting mechanism for counting impacts applied by the wrench, and control means for de-activating the impact wrench after application of a desired number of impacts.
